(19) United States
(12) Patent Application Publication
(10) Pub. No.: US 2025/0104634 A1
(43) Pub. Date: Mar. 27, 2025

(54) ELECTRO-OPTICAL DEVICE AND ELECTRONIC APPARATUS

(71) Applicant: SEIKO EPSON CORPORATION, Tokyo (JP)

(72) Inventor: Takehiko KUBOTA, Matsumoto-shi (JP)

(73) Assignee: SEIKO EPSON CORPORATION, Tokyo (JP)

(21) Appl. No.: 18/891,433

(22) Filed: Sep. 20, 2024

(30) Foreign Application Priority Data
Sep. 22, 2023 (JP) 2023-158343

(51) Int. Cl. G09G 3/3233

(52) U.S. Cl. CPC G09G 3/3233; G09G 2300/0819; G09G 2310/08; G09G 2320/045; G09G 2330/021

(57) ABSTRACT

A pixel circuit provided in correspondence with a scanning line and a data line includes a transistor and an OLED, where the transistor supplies current corresponding to a voltage between a gate node and a source node to the OLED in a light-emission period, sets the data line to a potential Vini in an initialization period, sets the gate node of the transistor to a threshold equivalent potential in a compensation period, sets the gate node of the transistor to a potential corresponding to a luminance of the OLED from the threshold equivalent potential in a write period, and sets the drain node of the transistor to a potential greater than or equal to the potential Vini and lower than a potential VBk in a drain set period.

The present application is based on, and claims priority from JP Application Serial Number 2023-158343, filed Sep. 22, 2023, the disclosure of which is hereby incorporated by reference herein in its entirety.

### BACKGROUND

### 1. Technical Field

The present disclosure relates to an electro-optical device and an electronic apparatus.

### 2. Related Art

In recent years, various types of electro-optical devices using light-emitting elements such as organic light-emitting diode (hereinafter referred to as “OLED”) elements have been proposed. In the electro-optical device, a pixel circuit including the light-emitting element a transistor that supplies current to drive the light-emitting element, and the like is provided in correspondence with a pixel of an image to be displayed, in accordance with an intersection of a scanning line and a data line.

When the electro-optical device is downsized, a capacitance is parasitized in each part of the electro-optical device. When the capacitance is parasitized on a drain node of the transistor that drives the light-emitting element, the charge remaining in the parasitic capacitance flows to the light-emitting element, leading to deterioration of display quality. Therefore, a technique of supplying a reset potential to the drain node of the transistor via a data line before supplying a current to the light-emitting element to cause the light-emitting element to emit light has been proposed (see e.g., JP-A-2023-50791).

However, as in the technique described in JP-A-2023-50791, when the reset potential is supplied to the drain node of the transistor via the data line, the potential amplitude of the data line increases, and low power consumption cannot be achieved by charging and discharging of the capacitance parasitized on the data line.

Therefore, an object of the present disclosure is to provide a technique for achieving low power consumption while suppressing deterioration in display quality due to charges remaining in a drain node of a transistor that drives a light-emitting element.

### SUMMARY

In order to solve the above problem, an electro-optical device according to one aspect of the present disclosure includes a pixel circuit provided in correspondence with a scanning line and a data line, in which the pixel circuit includes a first transistor and a light-emitting element, the first transistor supplies current corresponding to a voltage between a gate node of the first transistor and a source node of the first transistor to the light-emitting element in a light-emission period, sets the data line to a first potential in an initialization period before the light-emission period, sets the gate node of the first transistor to a second potential corresponding to a threshold voltage of the first transistor in a compensation period after the initialization period and before the light-emission period, sets the gate node of the first transistor to a third potential corresponding to a luminance of the light-emitting element from the second potential in a first period after the compensation period and before the light-emission period, and sets the drain node of the first transistor to a fourth potential greater than or equal to the first potential and smaller than the third potential in a second period after the first period and before the light-emission period.

### BRIEF DESCRIPTION OF THE DRAWINGS

FIG. 1 is a perspective view of an electro-optical device according to a first embodiment.

FIG. 2 is a block diagram illustrating an electrical configuration of the electro-optical device according to the first embodiment.

FIG. 3 is a diagram illustrating a pixel circuit of the electro-optical device according to the first embodiment.

FIG. 4 is a timing chart illustrating an operation of the electro-optical device according to the first embodiment.

FIG. 5 is a diagram illustrating an operation of the electro-optical device according to the first embodiment.

FIG. 6 is a diagram illustrating an operation of the electro-optical device according to the first embodiment.

FIG. 7 is a diagram illustrating an operation of the electro-optical device according to the first embodiment.

FIG. 8 is a diagram illustrating an operation of the electro-optical device according to the first embodiment.

FIG. 9 is a diagram illustrating an operation of the electro-optical device according to the first embodiment.

FIG. 10 is a diagram illustrating a potential range in a write period in the first embodiment.

FIG. 11 is a diagram illustrating a potential change of each part of the electro-optical device according to the first embodiment.

FIG. 12 is a block diagram illustrating an electrical configuration of an electro-optical device according to a second embodiment.

FIG. 13 is a timing chart illustrating an operation of the electro-optical device according to the second embodiment.

FIG. 14 is a block diagram illustrating an electrical configuration of an electro-optical device according to a third embodiment.

FIG. 15 is a diagram illustrating a pixel circuit of an electro-optical device according to a fourth embodiment.

FIG. 16 is a timing chart illustrating an operation of the electro-optical device according to the fourth embodiment.

FIG. 17 is a diagram illustrating a pixel circuit of an electro-optical device according to a fifth embodiment.

FIG. 18 is a diagram illustrating a pixel circuit of an electro-optical device according to a sixth embodiment.

FIG. 19 is a timing chart illustrating an operation of the electro-optical device according to the fifth and sixth embodiments.

FIG. 20 is a timing chart illustrating an operation of an electro-optical device according to a modified example.

FIG. 21 is a perspective view illustrating a head-mounted display using the electro-optical device.

FIG. 22 is a diagram illustrating an optical configuration of the head-mounted display.

FIG. 23 is a timing chart illustrating an operation of an electro-optical device according to a comparative example.

FIG. 24 is a diagram illustrating an operation of the electro-optical device according to the comparative example.

### DESCRIPTION OF EMBODIMENTS

An electro-optical device according to an embodiment will be described below with reference to the accompanying drawings. In each of the drawings, dimensions and scale of each part are made appropriately different from actual ones. Moreover, the embodiment described below is a suitable specific example, and various technically preferable limitations are applied, but the scope of the disclosure is not limited to these modes unless they are specifically described in the following description as limiting the disclosure.

### First Embodiment

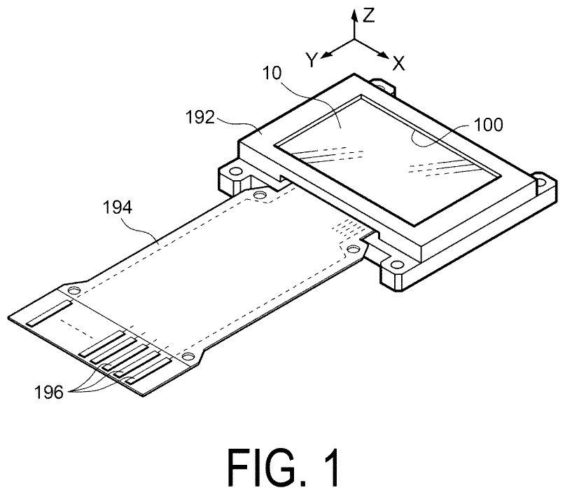

FIG. 1 is a perspective view illustrating an electro-optical device 10 according to a first embodiment. The electro-optical device 10 is a micro display panel that displays an image, for example, in a head-mounted display or the like. The electro-optical device 10 includes a pixel circuit including an OLED, a drive circuit for driving the pixel circuit, and the like. The pixel circuit, the drive circuit, and the like are integrated into a semiconductor substrate. The semiconductor substrate is typically a silicon substrate, but may be other semiconductor substrate.

The electro-optical device 10 is accommodated in a frame-shaped case 192 that opens in a display region 100. The electro-optical device 10 is connected to one end of an FPC substrate 194. Note that FPC is an abbreviation for flexible printed circuit. A plurality of terminals 196 that are connected to a host device, which is not illustrated in the drawing, are provided at the other end of the FPC substrate 194. When the plurality of terminals 196 are connected to the host device, video data, synchronization signals, and the like are supplied from the host device to the electro-optical device 10 via the FPC substrate 194.

In the drawings, an X direction is an extension direction of a scanning line in the electro-optical device 10, and a Y direction is an extension direction of a data line. A two-dimensional plane defined in the X direction and the Y direction is a substrate surface of a semiconductor substrate. A Z direction is perpendicular to the X direction and the Y direction and is an emission direction of light emitted from an OLED.

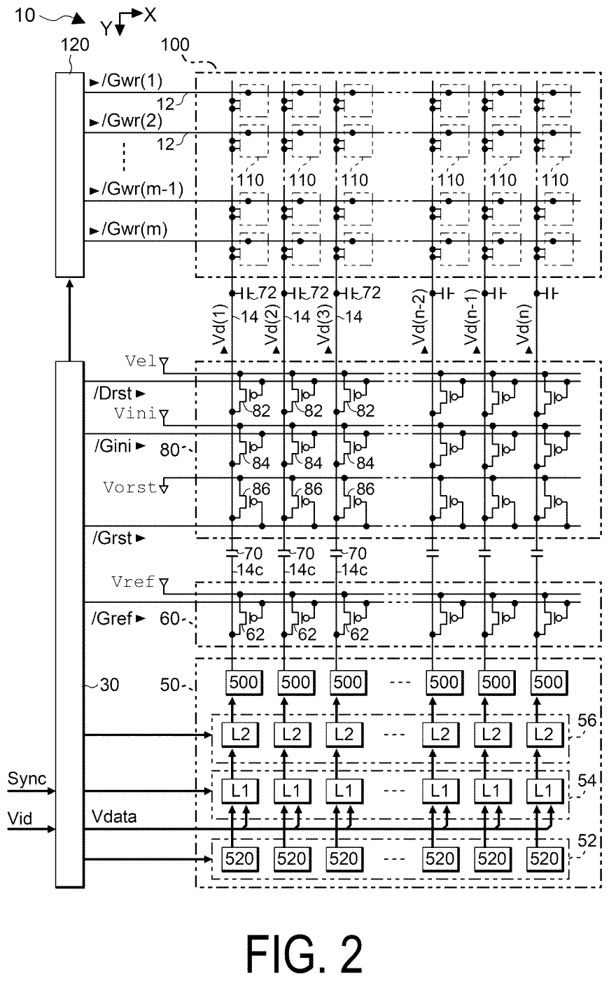

FIG. 2 is a block diagram illustrating an electrical configuration of the electro-optical device 10 according to the first embodiment. As illustrated in the drawing, the electro-optical device 10 includes a control circuit 30, a data signal output circuit 50, an auxiliary circuit 60, n capacitive elements 70, an initialization circuit 80, a display region 100, and a scanning line drive circuit 120. In the display region 100, scanning lines 12 of m rows are provided in the X direction in the drawing, and data lines 14 of n columns are provided in the Y direction to be electrically insulated from each of the scanning lines 12. Each of m and n is an integer greater than or equal to two.

In the display region 100, pixel circuits 110 are provided in correspondence with the intersections of the scanning lines 12 of the m rows and the data lines 14 of the n columns. For this reason, the pixel circuits 110 are arrayed in a matrix of m rows×n columns. In order to distinguish the rows from each other in the matrix array, the rows may be referred to as first, second, third, . . . , (m−1)-th, and m-th rows in order from the top in the drawing. Similarly, in order to distinguish the columns from each other in the matrix, the columns may be referred to as first, second, third, . . . , (n−1)-th, and n-th columns in order from the left in the drawing.

Note that an integer i of greater than or equal to one to less than or equal to m is used to generalize and describe the scanning line 12. Furthermore, an integer j of greater than or equal to one and less than or equal to n is used to generalize and describe the data lines 14.

The control circuit 30 controls each part, based on video data Vid and a synchronization signal Sync supplied from the high-order host device. The video data Vid designates, for example, a gradation level of a pixel in an image to be displayed by 8 bits.

The synchronization signal Sync includes a vertical synchronization signal for giving an instruction for starting vertical scanning of the video data Vid, a horizontal synchronization signal for giving an instruction for starting horizontal scanning, and a dot clock signal that indicates a timing of one pixel of the video data.

In the embodiment, the pixels of the image to be displayed and the pixel circuits 110 in the display region 100 correspond one-to-one with each other.

A characteristic of the brightness indicated by the gradation level in the video data Vid supplied from a host device does not necessarily match a characteristic of the luminance of the OLED included in the pixel circuits 110. Consequently, in order to cause the OLED to emit light at the luminance corresponding to the gradation level designated by the video data Vid, the control circuit 30 up-converts 8 bits of the video data Vid to, for example, 10 bits in the embodiment, and outputs as the video data Vdata. For this reason, the gradation level is also designated for the 10 bit video data Vdata. That is, the video data Vdata designates a gradation level obtained by converting the gradation level designated by the video data Vid.

Note that a look-up table is used for the up-conversion, for example, the look-up table being a table in which a correspondence relationship between the 8 bits of the video data Vid which is an input and the 10 bits of the video data Vdata which is an output is stored in advance. Furthermore, the control circuit 30 generates various control signals to control each part, and details thereof will be described later.

The scanning line drive circuit 120 is a circuit that outputs various signals to drive the pixel circuits 110 arrayed in m rows and n columns on a row-by-row basis under the control of the control circuit 30. For example, the scanning line drive circuit 120 supplies scanning signals /Gwr(1), /Gwr(2) . . . /Gwr(m−1), /Gwr(m) to the scanning lines 12 in the first, second, third . . . (m−1)-th, and m-th rows in order. In general, the scanning line drive circuit 120 supplies the scanning signal /Gwr (i) to the scanning line 12 of the i-th row. The scanning line drive circuit 120 outputs various control signals in addition to the scanning signals /Gwr(1) to/Gwr(m), and details thereof will be described later.

The data signal output circuit 50 is a circuit that outputs a voltage signal corresponding to the luminance to the pixel circuit 110 located in the row selected by the scanning line drive circuit 120. In detail, the data signal output circuit 50 includes a selection circuit group 52, a first latch circuit group 54, a second latch circuit group 56, and n DA conversion circuits 500.

The selection circuit group 52 includes selection circuits 520 in one-to-one correspondence with the n columns, the first latch circuit group 54 includes first latch circuits L1 in one-to-one correspondence with the n columns, and the second latch circuit group 56 includes second latch circuits L2 in one-to-one correspondence with the n columns. In addition, the n DA conversion circuits 500 correspond to n columns on a one-to-one basis.

That is, a set of the selection circuit 520, the first latch circuit L1, the second latch circuit L2, and the DA conversion circuit 500 is provided corresponding to each column. Here, the selection circuit 520 of the j-th column instructs the first latch circuit L1 of the j-th column to select video data of the j-th column from the video data Vdata output from the control circuit 30, and the first latch circuit L1 of the j-th column latches the video data Vdata according to the instruction. The second latch circuit L2 of the j-th column outputs the video data Vdata latched by the first latch circuit L1 of the j-th column to the DA conversion circuit 500 of the j-th column in a write period (C) described later under the control of the control circuit 30.

The DA conversion circuit 500 of the j-th column converts the 10 bit video data Vdata output from the second latch circuit L2 of the j-th column into an analog signal, and outputs the analog signal to a data signal output line 14c of the j-th column. In other words, the data signal output lines 14c are provided in one-to-one correspondence with the data lines 14, and an output end of the DA conversion circuit 500 of the j-th column is connected to the data signal output line 14c of the j-th column.

The auxiliary circuit 60 is an aggregate of transistors 62 provided in one-to-one correspondence with the data signal output lines 14c. A source node of the transistor 62 corresponding to the j-th column is connected to a power supply line of a potential Vref, and a drain node of the transistor 62 is connected to the data signal output line 14c of the j-th column. In addition, a control signal /Gref output from the control circuit 30 is commonly supplied to a gate node of the transistor 62 in each column.

The n capacitive elements 70 are provided in one-to-one correspondence with the sets of the data signal output lines 14c and the data lines 14. In detail, one end of the capacitive element 70 of the j-th column is connected to the data signal output line 14c of the j-th column, and the other end of the capacitive element 70 of the j-th column is connected to the data line 14 of the j-th column. The video data Vdata corresponds to the gradation level designated by the video data Vid, the DA conversion circuit 500 converts the video data Vdata into an analog signal, and the analog signal is supplied to the data line 14 as a data signal via the capacitive element 70. For this reason, the potential of the data signal supplied to the data line 14 corresponds to the gradation level designated by the video data Vid and the video data Vdata.

The initialization circuit 80 is an aggregate of a set of transistors 82, 84, and 86 provided in one-to-one correspondence with the data lines 14.

A source node of the transistor 82 corresponding to the j-th column is connected to the power supply line of a potential Vel, and a drain node of the transistor 82 is connected to the data line 14 of the j-th column. In addition, a control signal/Drst output from the control circuit 30 is commonly supplied to gate nodes of the transistors 82 in the respective columns. The potential Vel is used as a high potential of a power supply voltage.

A source node of the transistor 84 corresponding to the j-th column is connected to the power supply line of a potential Vini, and a drain node of the transistor 84 is connected to the data line 14 of the j-th column. In addition, a control signal /Gini output from the control circuit 30 is commonly supplied to gate nodes of the transistors 84 in the respective columns.

A source node of the transistor 86 corresponding to the j-th column is connected to the power supply line of a potential Vorst, and a drain node of the transistor 86 is connected to the data line 14 of the j-th column. In addition, a control signal /Grst output from the control circuit 30 is commonly supplied to the gate nodes of the transistors 86 in the respective columns. The potential Vorst is, for example, a potential Gnd or a low potential close to the potential Gnd. Specifically, the potential Vorst is a potential at which a current does not flow through the OLED if power is supplied to the anode of the OLED. Note that the potential Gnd is a ground potential and is a reference potential of zero voltage.

Note that in the present embodiment, the control signals/Drst and/Grst are always at H level, and thus the transistors 82 and 86 of the respective columns are always in the off state. Therefore, in the present embodiment, the transistors 82 and 86 do not have an electrical meaning. However, they are left for comparison with a comparative example described later.

A capacitance component is parasitized on the data line 14 in each column. In the drawing, the capacitance component is represented as a parasitic capacitance 72. The parasitic capacitance 72 is represented as a capacitive element having one end electrically connected to the data line 14 and the other end electrically connected to a power supply line having a constant potential, for example, a potential Gnd.

In the drawing, the potentials of the data lines 14 in the first, second, . . . , (n−1)-th, and n-th columns are denoted by Vd(1), Vd(2), . . . , Vd(n−1), and Vd(n), respectively. In general, the potential of the data line 14 of the j-th column is denoted as Vd(j).

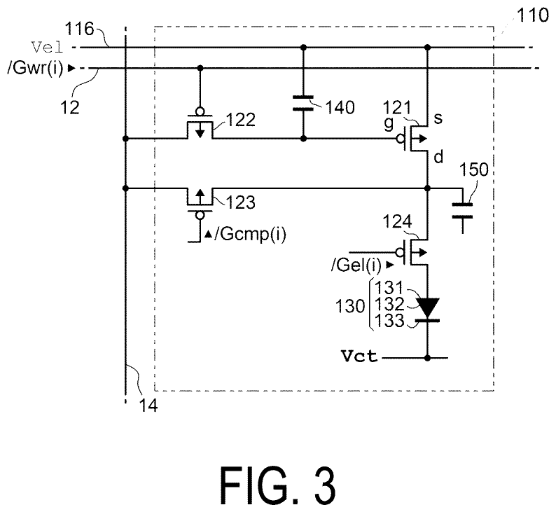

FIG. 3 is a circuit diagram illustrating the pixel circuit 110. The pixel circuits 110 arranged in m rows and n columns are electrically identical to each other. Thus, the pixel circuit 110 will be described with the pixel circuit 110 located at the i-th row and the j-th column as a representative.

As illustrated in the drawing, the pixel circuit 110 includes an OLED 130, p-type transistors 121 to 124, and a capacitive element 140. The transistors 121 to 124 are, for example, MOS transistors. MOS is an abbreviation for metal-oxide-semiconductor field-effect transistor.

Furthermore, in addition to a scanning signal /Gwr(i) corresponding to the i-th row, control signals /Gel(i) and /Gcmp(i) are supplied from the scanning line drive circuit 120 to the pixel circuit 110 of the i-th row.

The control signal /Gel(i) is denoted to generalize the control signals /Gel(1), /Gel(2) . . . /Gel(m−1), and /Gel(m) that are sequentially supplied in correspondence with the first, second . . . (m−1)-th, and m-th rows. Similarly, the control signal /Gcmp(i) is denoted to generalize the control signals /Gcmp(1), /Gcmp(2) . . . /Gcmp(m−1), and /Gcmp(m) that are sequentially supplied corresponding to the first, second . . . (m−1)-th, and m-th rows.

The OLED 130 is a light-emitting element in which a light-emitting functional layer 132 is sandwiched between a pixel electrode 131 and a common electrode 133. The pixel electrode 131 functions as an anode, and the common electrode 133 serves as a cathode. The common electrode 133 is light-transmissive.

In the OLED 130, when current flows from the anode to the cathode, holes injected from the anode and electrons injected from the cathode are recombined in the light-emitting functional layer 132 to generate excitons, and white light is generated.

In the case of color display, the generated white light resonates in an optical resonator configured by, for example, a reflective layer and a semi-reflective and semi-transmissive layer, which are not illustrated in the drawing, and is emitted with a resonance wavelength set in correspondence with any one color of red (R), green (G), and blue (B). A color filter corresponding to the color is provided on the emission side of the light from the optical resonator. Thus, the exit light from the OLED 130 is sequentially passed through the optical resonator and the coloring by the color filter, and is visually recognized by the observer. The optical resonator is not illustrated in the drawing. In addition, when the electro-optical device 10 merely displays a monochrome image having only light and dark, the optical resonator and the color filter are omitted.

In the transistor 121 of the pixel circuit 110 of the i-th row and the j-th column, a gate node g is connected to the drain node of the transistor 122, a source node s is connected to the power supply line 116 to which the potential Vel is supplied, and a drain node d is connected to the source node of the transistor 123 and the source node of the transistor 124.

A capacitance component is parasitized on the drain node d of the transistor 121. In the drawing, the capacitance component is denoted as a parasitic capacitance 150. The parasitic capacitance 150 is represented as a capacitive element having one end electrically connected to the drain node d and the other end electrically connected to a power supply line having a constant potential, for example, a potential Gnd.

In the capacitive element 140, one end is connected to the gate node g of the transistor 121, and the other end is connected to the power supply line 116. For this reason, the capacitive element 140 holds a voltage between the gate node g and the source node s in the transistor 121.

The other end of the capacitive element 140 may be connected to a power supply line having a potential other than the power supply line 116 having the potential Vel as long as the potential is maintained substantially constant.

In the embodiment, for example, a so-called MOS capacitance, which is formed by interposing a gate insulating layer of a transistor between a semiconductor layer (lower electrode) and a gate electrode layer (upper electrode) of the transistor, is used as the capacitive element 140. As the capacitive element 140, a parasitic capacitance of the gate node g of the transistor 121 may be used, or a so-called metal capacitance formed by interposing an insulating layer between conductive layers different from each other in the semiconductor substrate may be used.

In the transistor 122 of the pixel circuit 110 at the i-th row and the j-th column, a gate node is connected to the scanning line 12 in the i-th row, and a source node is connected to the data line 14 in the j-th column. In the transistor 123 of the pixel circuit 110 at the i-th row and the j-th column, a control signal /Gcmp(i) is supplied to a gate node thereof, and a drain node is connected to the data line 14 in the j-th column. In the transistor 124 of the pixel circuit 110 of the i-th row and the j-th column, the control signal /Gel(i) is supplied to the gate node, and the drain node is connected to the pixel electrode 131 which is the anode of the OLED 130.

Note that, in the transistors 122, 123, and 124, when the direction in which the current flows is inverted, the source node and the drain node are switched, but in the present description, the source node and the drain node are as described above.

A potential Vct is supplied to the common electrode 133 functioning as the cathode of the OLED 130. The potential Vct is, for example, the potential Gnd or a low potential close to the potential Gnd. In such a pixel circuit 110, a series connection body of the transistors 123 and 124 is provided in a path from the data line 14 to the pixel electrode 131, and the transistor 124 is provided between the drain node d of the transistor 121 and the pixel electrode 131.

In the present description, “electrically connected” or simply “connected” means direct or indirect connecting or coupling between two or more elements, and includes, for example, coupling between two or more elements via different wiring layers and contact holes even when the two or more elements are not directly connected in a semiconductor substrate.

Furthermore, although the pixel circuit 110 in the i-th row and the j-th column has been described here, the pixel circuits 110 in other rows and other columns have the same configuration.

The control circuit 30 controls driving of the pixel circuit 110 via the data signal output circuit 50, the auxiliary circuit 60, the initialization circuit 80, and the scanning line drive circuit 120. For this reason, the control circuit 30, the data signal output circuit 50, the auxiliary circuit 60, the initialization circuit 80, and the scanning line drive circuit 120 may be referred to as a control circuit in a broad sense that controls the pixel circuit 110.

Next, an operation of the electro-optical device 10 will be described.

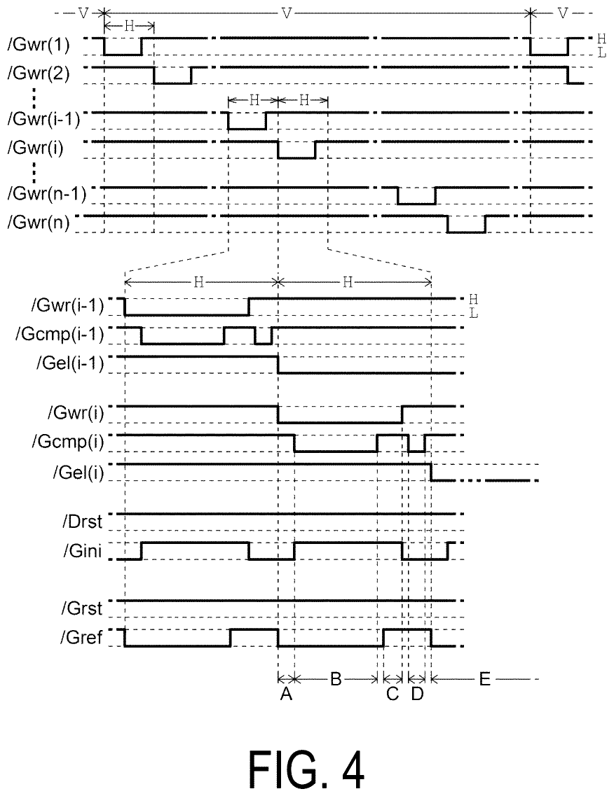

FIG. 4 is a timing chart for explaining the operation of the electro-optical device 10 according to the first embodiment. Specifically, FIG. 4 is a timing chart illustrating an operation of one frame and an operation of two consecutive horizontal scanning periods in the one frame in the electro-optical device 10.

In the present description, one frame is referred to. One frame is a period required to display one shot of an image designated by the video data Vid. When the temporal length of one frame is the same as the vertical synchronization period, for example, when the frequency of the vertical synchronization signal included in the synchronization signal Sync is 60 Hz, the temporal duration of one frame is 16.7 milliseconds, which corresponds to one period of the vertical synchronization signal.

In the electro-optical device 10, in each frame (V), the scanning lines 12 of m rows are selected row by row in the order of 1, 2, 3, . . . , m-th row and horizontally scanned. A period required for horizontal scanning of one row is a horizontal scanning period (H).

In the present embodiment, the horizontal scanning period (H) is divided into an initialization period (A), a compensation period (B), a write period (C), and a drain set period (D) in order of time. Furthermore, as the operation of the pixel circuit 110, a light-emission period (E) is further added in addition to the initialization period (A), the compensation period (B), the write period (C), and the drain set period (D).

The initialization period (A) is a period for supplying the potential Vini for turning the transistor 121 to the ON state to the gate node g via the data line 14.

The compensation period (B) is a period for converging the gate node g of the transistor 121 to a potential corresponding to a threshold voltage of the transistor 121.

The write period (C) is a period in which the potential corresponding to the gradation level is held (written) in the gate node g of the transistor 121, and in detail, is a period for changing the gate node g of the transistor 121 by a voltage corresponding to a current flowing to the OLED 130 from the potential corresponding to the threshold voltage.

The drain set period (D) is a period in which the potential Vini is set to the drain node d of the transistor 121. Note that the potential Vini set at the drain node d is held by the parasitic capacitance 150.

The light-emission period (E) is a period for causing a current corresponding to the potential of the gate node g held in the write period (C) to flow through the OLED 130 to emit light.

In the present description, the “ON state” of the transistor means that a space between the source node and the drain node in the transistor is electrically closed to be in a low impedance state. Also, an “OFF state” of the transistor means that the space between the source node and the drain node is electrically opened to be in a high impedance state.

In the present embodiment, the operation of each frame is common. Furthermore, in one frame (V), the operation in the horizontal scanning period (H) in each row is common. Furthermore, the operation of the pixel circuits 110 of the first to n-th columns of the first row scanned in one horizontal scanning period (H) is common.

Therefore, in the following, the operation of the pixel circuit 110 of the i-th row and the j-th column will be described by way of an example for the horizontal scanning period (H) of the i-th row in each frame.

In one frame (V), in the initialization period (A) of each horizontal scanning period (H), the control signal /Gini is at the L level, and the control signal /Gref is at the L level. Therefore, the transistor 84 of each column is in an ON state, and the transistor 62 of each column is in an ON state.

Furthermore, in the initialization period (A) of the horizontal scanning period (H) of the i-th row, the scanning signal /Gwr(i) is at the L level, the control signal /Gcmp(i) is at the H level, and the control signal /Gel(i) is at the H level. For this reason, in the initialization period (A), in the pixel circuit 110 of the i-th row and the j-th column, the transistor 122 is in an ON state, the transistor 123 is in an OFF state, and the transistor 124 is in an OFF state.

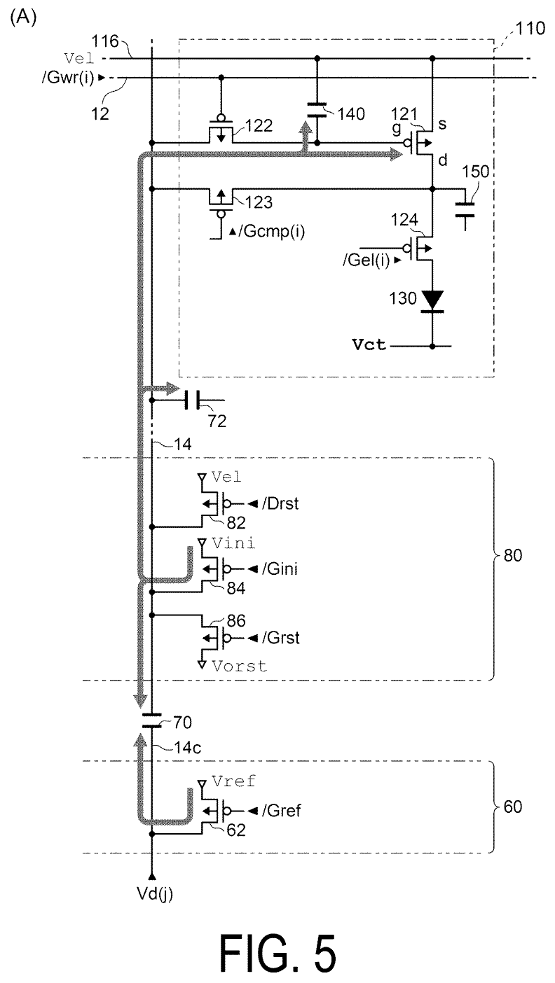

Therefore, in the initialization period (A), as illustrated in FIG. 5, in the pixel circuit 110 of the i-th row and the j-th column, the potential Vini is supplied to one end of the capacitive element 140 and the gate node g of the transistor 121 via the transistor 84, the data line 14 of the j-th column, and the transistor 122 in order.

In the initialization period (A), since the transistor 62 is in the ON state in each column, the data signal output line 14c, that is, one end of the capacitive element 70 becomes the potential Vref.

As described above, in the initialization period (A), the data line 14 of the j-th column, that is, the other end of the capacitive element 70 is at the potential Vini.

Thus, in each column, a voltage across both ends of the capacitive element 70 is set to |Vref-Vini|, and one end of the parasitic capacitance 72 is held at the potential Vini.

Note that the potentials Vini and Vorst are in a relationship of:

Vini>Vorst.

In the compensation period (B) of each horizontal scanning period (H), the control signal /Gini changes to the H level, and the control signal /Gref maintains the L level. Therefore, the transistor 84 of each column changes to the OFF state, and the transistor 62 of each column maintains the ON state.

Furthermore, in the compensation period (B) of the horizontal scanning period (H) of the i-th row, the scanning signal /Gwr(i) is maintained at the L level, the control signal /Gcmp(i) is changed to the L level, and the control signal /Gel(i) is maintained at the H level. Therefore, in the pixel circuit 110 of the i-th row and the j-th column, the transistor 122 is maintained in the ON state, the transistor 123 is changed to the ON state, and the transistor 124 is maintained in the OFF state.

In the pixel circuit 110 in the i-th row at the beginning of the compensation period (B), the gate node g of the transistor 121 is at the potential Vini. When the transistor 123 is in the ON state while the gate node g is at the potential Vini, the transistor 121 is in a diode-connected state, that is, a state in which the gate node g and the drain node d are connected.

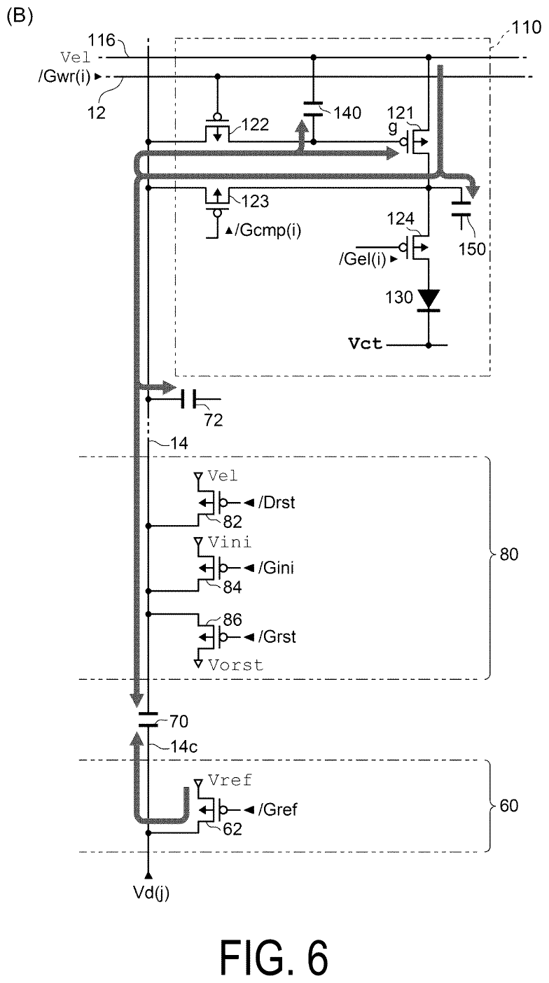

Thus, as illustrated in FIG. 6, in the compensation period (B), a voltage between the gate node g and the source node s in the transistor 121 approaches (a voltage close to) a threshold voltage Vth of the transistor 121. That is, the potentials of the gate node g, the drain node d, and the data line 14 in the transistor 121 approach the threshold equivalent potential (Vel-Vth).

In the compensation period (B), since the transistor 62 maintains the ON state in each column, one end of the capacitive element 70 maintains the potential Vref. Furthermore, in the compensation period (B), the data line 14, which is the other end of the capacitive element 70, approaches the threshold equivalent potential (Vel-Vth). Therefore, in each column, the voltage across both ends of the capacitive element 70 becomes |Vel-Vth-Vref|, and one end of the parasitic capacitance 72 is held at the threshold equivalent potential (Vel-Vth).

In the write period (C) of each horizontal scanning period (H), the control signal /Gini maintains the H level, and the control signal /Gref changes to the H level. Therefore, the transistor 84 of each column maintains the OFF state, and the transistor 62 of each column maintains the OFF state.

In the write period (C) of the horizontal scanning period (H) of the i-th row, the scanning signal /Gwr(i) is maintained at the L level, the control signal /Gcmp(i) is changed to the H level, and the control signal /Gel(i) is maintained at the H level. Therefore, in the pixel circuit 110 of the i-th row and the j-th column, the transistor 122 is maintained in the ON state, the transistor 123 is changed to the OFF state, and the transistor 124 is maintained in the OFF state.

In the write period (C), the transistor 62 in each column changes to the OFF state. Furthermore, the 10 bit video data Vdata corresponding to the i-th row and the column is supplied to the DA conversion circuit 500 in each of the columns. For this reason, the DA conversion circuit 500 of the j-th column outputs a signal having a potential corresponding to the gradation level of the i-th row and the j-th column to the data signal output line 14c.

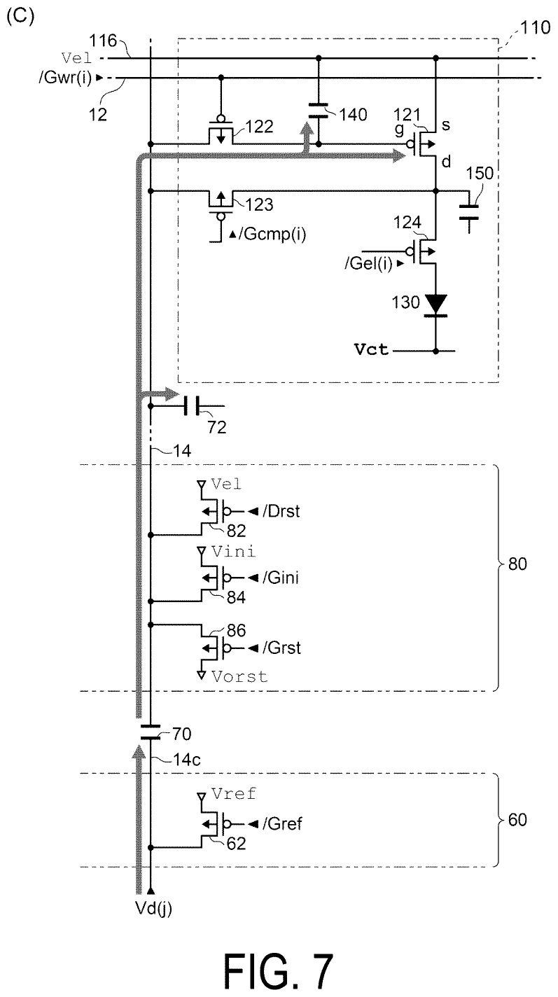

Thus, as illustrated in FIG. 7, in the write period (C), the potential at one end of the capacitive element 70 of the j-th column rises from the potential Vref to the potential of the gradation level corresponding to the i-th row and the j-th column. Such a potential rise reaches the gate node g of the transistor 121 via the capacitive element 70, the data line 14, and the transistor 122 in order.

The potential change of the gate node g in the write period (C) is a value obtained by multiplying the potential rise of the data signal output line 14c, that is, the one end of the capacitive element 70 by the ratio of the capacitance value of the capacitive element 70 with respect to the “combined capacitance value”. Here, the “combined capacitance value” is a capacitance value of a combined capacitance of the capacitive element 70, the parasitic capacitance 72, and the capacitive element 140. Note that the capacitance value of the capacitive element 140 is negligible when it is sufficiently small compared to the other capacitance values.

The potential changes of the data signal output line 14c and the data line 14 in the write period (C) will be described with reference to FIG. 10.

The potential corresponding to the gradation level output from the DA conversion circuit 500 to the data signal output line 14c is in a range from the potential Bk corresponding to the black level of the lowest gradation to the potential Wt corresponding to the white level of the highest gradation. The potential in the range is compressed into a range from a potential Vbk (≈Vel) to a potential Vwt slightly lower than the potential Vbk by distribution of charges by the capacitive element 70 and the parasitic capacitance 72, and reaches the data line 14 and the gate node g.

When the scanning signal /Gwr (i) becomes the H level, the write period (C) ends. In the pixel circuit 110 of the i-th row and the j-th column, the transistor 122 is in the OFF state, but the voltage of the difference between the potential of the gate node g and the potential Vel of the source node s is held in the capacitive element 140.

In the present embodiment, the drain set period (D) is reached after the end of the write period (C). In the drain set period (D) of each horizontal scanning period (H), the control signal /Gini changes to the L level, and the control signal /Gref maintains the H level. Therefore, the transistor 84 of each column changes to the ON state, and the transistor 62 of each column maintains the OFF state.

In the drain set period (D) of the horizontal scanning period (H) of the i-th row, the scanning signal /Gwr (i) changes to the H level, the control signal /Gcmp (i) changes to the L level, and the control signal /Gel (i) maintains the H level. Therefore, in the pixel circuit 110 of the i-th row and the j-th column, the transistor 122 is changed to the OFF state, the transistor 123 is changed to the ON state, and the transistor 124 is maintained in the OFF state.

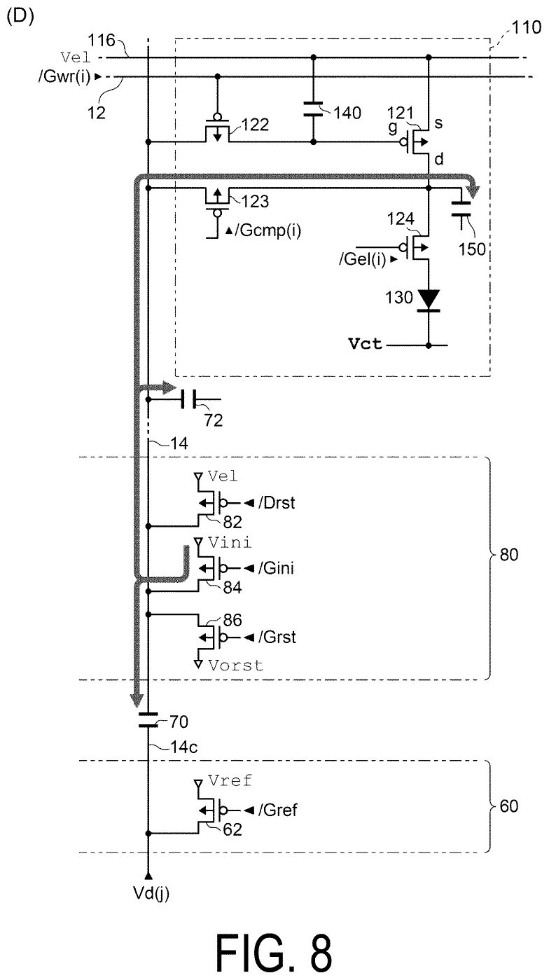

Therefore, in the drain set period (D), as illustrated in FIG. 8, in the pixel circuit 110 of the i-th row and the j-th column, the potential Vini is supplied to the drain node d of the transistor 121 via the transistor 84, the data line 14 of the j-th column, and the transistor 123 in this order.

Therefore, in the drain set period (D), the drain node d, that is, one end of the parasitic capacitance 150 is set to the potential Vini. As described above, the potential Vini is a potential that turns the transistor 121 to the ON state when supplied to the gate node g, and is a potential lower than the potential Vel and higher than the potential Vorst.

In the present embodiment, the light-emission period (E) is reached after the end of the drain set period (D). In the light-emission period (E) of the i-th row, the control signal /Gel(i) is inverted to the L level, and thus the transistor 124 is in the ON state.

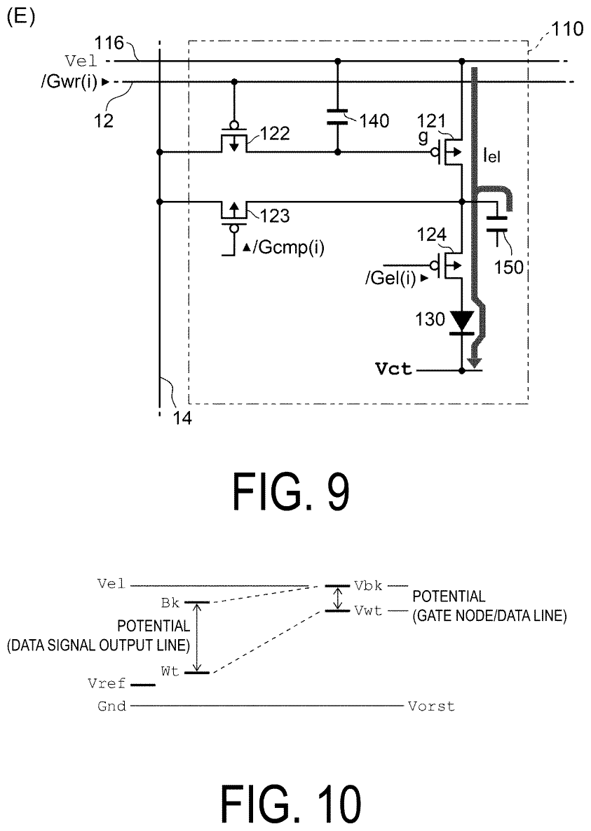

Therefore, as illustrated in FIG. 9, in the light-emission period (E), a current Iel corresponding to the potential of the gate node g held by the capacitive element 140 flows to the OLED 130 in the pixel circuit 110 of the i-th row and the j-th column by the transistor 121. For this reason, the OLED 130 emits light with a luminance corresponding to the current Iel.

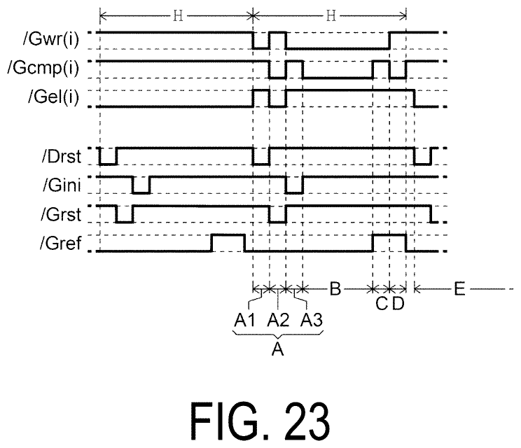

FIG. 23 is a timing chart for explaining an operation of a comparative example for explaining the superiority of the electro-optical device 10 according to the first embodiment.

The configuration of the electro-optical device according to the comparative example is the same as the configuration illustrated in FIGS. 2 and 3, but the control signals supplied from the control circuit 30 and the scanning line drive circuit 120 have waveforms as illustrated in FIG. 23 unlike the first embodiment.

In the comparative example, the initialization period (A) is divided into three initialization periods (A1), (A2), and (A3). Among them, the initialization period (A1) is a period for setting the transistor 121 to the OFF state. The initialization period (A2) is a period for resetting the potential at the anode of OLED130, and the initialization period (A3) is a period for applying the potential Vini for turning the transistor 121 to the ON state at the beginning of the compensation period (B) to the gate node g via the data line 14.

In the comparative example, in the initialization period (A1) of each horizontal scanning period (H), the control signal/Drst is at the L level, the control signal /Gini is at the H level, the control signal /Grst is at the H level, and the control signal /Gref is at the L level. Therefore, the transistor 82 is in the ON state, the transistor 84 is in the OFF state, the transistor 86 is in the OFF state, and the transistor 62 is in the ON state.

Furthermore, in the comparative example, in the initialization period (A1) of the horizontal scanning period (H) in which the i-th row is selected, the scanning signal /Gwr (i) is at the L level, the control signal /Gcmp (i) is at the H level, and the control signal /Gel (i) is at the H level. Therefore, in the pixel circuit 110, the transistor 122 is in the ON state, and the transistors 123 and 124 are in the OFF state.

Therefore, in the comparative example, in the pixel circuit 110 in the i-th row in the initialization period (A1), the potential Vel is supplied to the gate node g of the transistor 121 via the data line 14 and the transistor 122 in this order. When the potential Vel is supplied to the gate node g, the voltage between the gate node and the source node becomes zero, so that the transistor 121 is forcibly turned to the OFF state. Note that one end of the capacitive element 70 is fixed at the potential Vref.

In the comparative example, in the initialization period (A2) of each horizontal scanning period (H), the control signal/Drst changes to the H level, the control signal /Gini maintains the H level, the control signal /Grst changes to the L level, and the control signal /Gref maintains the L level. Therefore, the transistor 82 changes to the OFF state, the transistor 84 maintains the OFF state, the transistor 86 changes to the ON state, and the transistor 62 maintains the ON state.

In the comparative example, in the initialization period (A2) of the horizontal scanning period (H) in which the i-th row is selected, the scanning signal /Gwr (i) changes to the H level, the control signal /Gcmp (i) changes to the L level, and the control signal /Gel (i) changes to the L level. Therefore, in the pixel circuit 110, the transistor 122 changes to the OFF state, and the transistors 123 and 124 change to the ON state.

Therefore, in the comparative example, in the pixel circuit 110 in the i-th row of the initialization period (A2), the potential Vorst is supplied to the pixel electrode 131 that is the anode of the OLED130 via the data line 14 and the transistors 123 and 124 in this order. When the potential Vorst is supplied to the pixel electrode 131, the OLED130 is forcibly turned off. In addition, since the potential Vorst passes through the drain node d of the transistor 121, the charge remaining in the parasitic capacitance 150 is reset. Note that one end of the capacitive element 70 is fixed at the potential Vref.

In the comparative example, the initialization period (A3), the compensation period (B), and the write period (C) of the horizontal scanning period (H) in which the i-th row is selected are the same as the initialization period (A), the compensation period (B), and the write period (C) in the first embodiment in this order.

That is, in the comparative example, in the horizontal scanning period (H) in which the i-th row is selected, in the initialization period (A3), the potential Vini is supplied to the gate node g of the transistor 121 in the pixel circuit 110 of the i-th row, in the compensation period (B), the gate node g approaches the threshold equivalent potential (Vel-Vth), and in the write period (C), the potential corresponding to the gradation level is held in the gate node g of the transistor 121.

In the comparative example, in the drain set period (D) of each horizontal scanning period (H), the control signal/Drst is at the H level, the control signal /Gini is at the H level, the control signal /Grst is at the H level, and the control signal /Gref is at the H level. Therefore, the transistor 82 is in the OFF state, the transistor 84 is in the OFF state, the transistor 86 is in the OFF state, and the transistor 62 is in the OFF state.

In the comparative example, in the drain set period (D) of the horizontal scanning period (H) in which the i-th row is selected, the scanning signal /Gwr (i) is at the H level, the control signal /Gcmp (i) is at the L level, and the control signal /Gel (i) is at the H level. Therefore, in the pixel circuit 110, the transistor 122 is in the OFF state, the transistor 123 is in the ON state, and the transistor 124 is in the OFF state.

Furthermore, in the drain set period (D), the control signal /Gref (i) is at the H level continuously from the write period (C). Thus, the transistor 62 is in the OFF state.

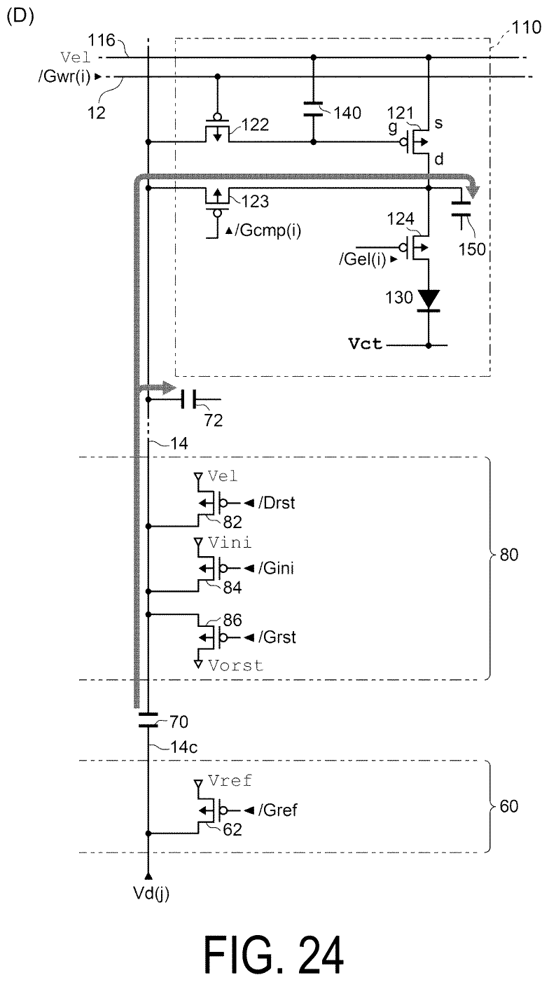

Therefore, in the comparative example, in the pixel circuit 110 in the i-th row of the drain set period (D), as illustrated in FIG. 24, the potential held in the data line 14 and the parasitic capacitance 72 in the write period (C), that is, the potential according to the gradation level is supplied to the drain node d of the transistor 121 via the transistor 123.

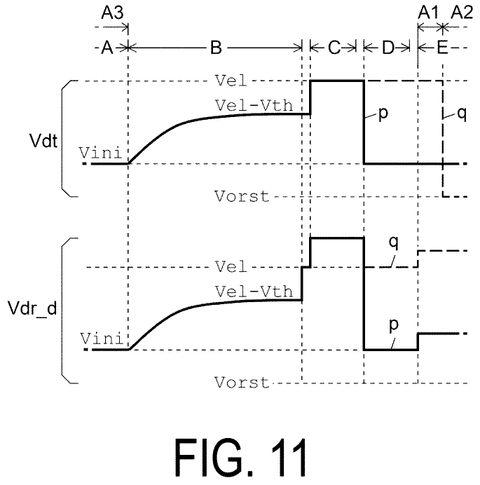

FIG. 11 is a diagram illustrating a potential change of each part in the pixel circuit 110 of the electro-optical device 10 according to the first embodiment in comparison with the comparative example.

Here, the potential of the data line 14 is denoted as Vdt, and the potential at the drain node d of the transistor 121 is denoted as Vdr_d. Furthermore, here is an example of a case where the OLED130 in the pixel circuit 110 is set to the black level of the lowest gradation. Furthermore, the potential change in the first embodiment is indicated by a solid line p, and the potential change in the comparative example is indicated by a broken line q.

In this case, in the first embodiment, the potential Vdt of the data line 14 becomes the potential Vini in the initialization period (A), approaches the threshold equivalent potential (Vel-Vth) in the compensation period (B), and becomes the potential Vbk corresponding to the black level in the write period (C). As described above, the potential Vbk is substantially equal to the potential Vel. In the first embodiment, the potential Vdt of the data line 14 becomes the potential Vini in the drain set period (D). Since the light-emission period (E) is also the initialization period (A) in the next horizontal scanning period, the potential Vdt of the data line 14 becomes the potential Vini in the first embodiment.

In the comparative example, the potential Vdt of the data line 14 becomes the potential Vini in the initialization period (A3) that is the end of the initialization period (A), approaches the threshold equivalent potential (Vel-Vth) in the compensation period (B), and becomes the potential Vbk in the write period (C). The above is the same as the first embodiment. In the comparative example, the potential Vdt of the data line 14 is maintained at the potential Vbk (≈Vel) corresponding to the gradation level in the write period (C), and is also maintained in the drain set period (D). Note that in the comparative example, since the light-emission period (E) is the initialization period (A1) in the next horizontal scanning period, the potential Vdt of the data line 14 is the potential Vel and hardly changes.

In the first embodiment, since the transistor 123 is in the ON state in the compensation period (B), the potential Vdr_d at the drain node d of the transistor 121 approaches the threshold equivalent potential (Vel-Vth) similarly to the potential Vdt.

In the first embodiment, when the transistor 123 changes to the OFF state at the end of the compensation period (B), the gate node g is substantially at the threshold equivalent potential (Vel-Vth), so that the transistor 121 is turned to the ON state. Therefore, the potential Vdr_d at the drain node d of the transistor 121 rises to the potential Vel. In the write period (C), the gate node g rises from the threshold equivalent potential (Vel-Vth) to the potential Vbk (≈Vel) corresponding to the black level. This potential rise is propagated to the drain node d via a capacitance parasitized between the gate node and the source node in the transistor 121. Therefore, in the write period (C), the potential Vdr_d at the drain node d of the transistor 121 further rises from the potential Vel.

In the first embodiment, the potential Vdr_d at the drain node d becomes the potential Vini by the ON state of the transistor 123 in the drain set period (D). At the end of the drain set period (D) or the beginning of the light-emission period (E), the transistor 123 changes from the ON state to the OFF state, so that the potential Vdr_d at the drain node d rises from the potential Vini. That is, the control signal /Gcmp (i) of the i-th row changes from the L level to the H level, and this potential rise is propagated to the drain node d via the capacitance parasitized between the gate node and the source node in the transistor 123, so that the potential Vdr_d rises from the potential Vini.

In the comparative example, the potential Vdr_d at the drain node d of the transistor 121 approaches the threshold equivalent potential (Vel-Vth) in the compensation period (B), rises to the potential Vel at the end of the compensation period (B), and rises again to the potential Vbk (≈Vel) corresponding to the black level in the write period (C). The above is the same as the first embodiment. In the comparative example, since the transistor 123 is turned ON in a state where the transistor 84 is turned OFF in the drain set period (D), the potential Vdr_d of the drain node d is equal to the potential Vbk (≈Vel) of the potential Vdt of the data line 14.

At the end of the drain set period (D) or the beginning of the light-emission period (E), the transistor 123 changes from the ON state to the OFF state, so that the potential Vdr_d at the drain node d rises from the potential Vbk (≈Vel).

In a case where the OLED130 in the pixel circuit 110 is set to the black level of the lowest gradation, in the drain set period (D), in the comparative example, the potential Vdr_d of the drain node d of the transistor 121 is substantially the potential Vel, and the potential Vel is held by the parasitic capacitance 150. That is, charge remains in the parasitic capacitance 150. In this state, when reaching the light-emission period (E) and the transistor 124 changes to the ON state, the charge remaining in the parasitic capacitance 150 flows into the OLED130, and the OLED130 slightly emits light. Therefore, in the comparative example, although it is desired to express the black level of the lowest gradation level, realization of a high contrast ratio is hindered as the OLED130 slightly emits light.

On the other hand, in the first embodiment, when the OLED130 is set to the black level of the lowest gradation, the potential Vdr_d of the drain node d of the transistor 121 is the potential ini lower than the potential Vel in the drain set period (D). Therefore, in the first embodiment, since the charge remaining in the parasitic capacitance 150 is less than that in the comparative example, even if the light-emission period (E) is reached and the charge remaining in the parasitic capacitance 150 flows into the OLED130, the degree of light emission of the OLED130 is smaller than that in the comparative example.

Therefore, in the first embodiment, a higher contrast ratio than in the comparative example can be realized.

Furthermore, in the comparative example, in the case of black level display, the potential Vdt of the data line 14 becomes the potential Vbk (≈Vel) in the drain set period (D), becomes the potential Vel in the initialization period (A1) of the next horizontal scanning period (H), becomes the potential Vorst in the initialization period (A2), and becomes the potential Vini in the initialization period (A3). That is, in the comparative example, the potential Vdt of the data line 14 falls from the potential Vel to the potential Vorst and then rises to the potential Vini in a period from the drain set period (D) to the initialization period of the next horizontal scanning period.

On the other hand, in the first embodiment, the potential Vdt of the data line 14 is the potential Vini in the drain set period (D), and is also the potential Vini in the initialization period (A) of the next horizontal scanning period (H). That is, in the first embodiment, the potential Vdt of the data line 14 is constant at the potential Vini from the drain set period (D) to the initialization period of the next horizontal scanning period.

Therefore, in the first embodiment, the power consumed by the parasitic capacitance 72 by the potential amplitude of the data line 14 is suppressed as compared with the comparative example.

In the technique described in JP 2023-50791 A, the potential Vorst is supplied to the drain node d of the transistor 121 in a period corresponding to the drain set period (D), whereas in the first embodiment, it is the potential Vini higher than the potential Vorst. Therefore, in the case of black level display, the drop in the potential Vdt of the data line 14 from the write period (C) to the drain set period (D) is smaller in the first embodiment than in the technique described in JP-A-2023-50791.

In the technique described in JP-A-2023-50791, in the case of black level display, the potential Vdt of the data line 14 becomes the potential Vorst in the drain set period (D), becomes the potential Vel in the initialization period (A1) of the next horizontal scanning period (H), becomes the potential Vorst in the initialization period (A2), and becomes the potential Vini in the initialization period (A3).

On the other hand, in the first embodiment, the potential Vdt of the data line 14 is constant at the potential Vini from the drain set period (D) to the initialization period of the next horizontal scanning period as described above.

Therefore, in the first embodiment, the power consumed by the parasitic capacitance 72 by the potential amplitude of the data line 14 is suppressed not only in the comparative example but also in the technique described in JP-A-2023-50791.

In the first embodiment described above, when the potential Vini is supplied to the gate node g, the transistor 121 needs to be in the ON state. Therefore, the potential Vini needs to be lower than the threshold equivalent potential (Vel-Vth) of the transistor 121.

However, when the potential Vini is set to be low, it is necessary to set the compensation period (B) long in order to compensate for variations in the threshold characteristics of all the transistors 121, which inhibits shortening of the horizontal scanning period due to high resolution. In addition, when the potential Vini is set low, the potential amplitude of the data line 14 increases, and the power consumed by the parasitic capacitance 72 increases, and thus it is difficult to reduce the power consumption. In order for the gate node g of the transistor 121 to approach the ideal threshold equivalent potential (Vel-Vth) at the end of the compensation period (B), it is important to set the potential Vini to be supplied to the gate node g of the transistor 121 at the beginning of the compensation period (B). As described above, various restrictions need to be cleared in determining the potential Vini.

As described above, when the potential Vini that needs to clear various restrictions is set in the drain node in the drain set period (D), there is a case where slight light emission caused by the charge remaining in the parasitic capacitance 150 flowing into the OLED130 at the beginning of the light-emission period (E) cannot be sufficiently suppressed. Therefore, a second embodiment using a potential other than the potential Vini as the potential to be set to the drain node in the drain set period (D) will be described.

### Second Embodiment

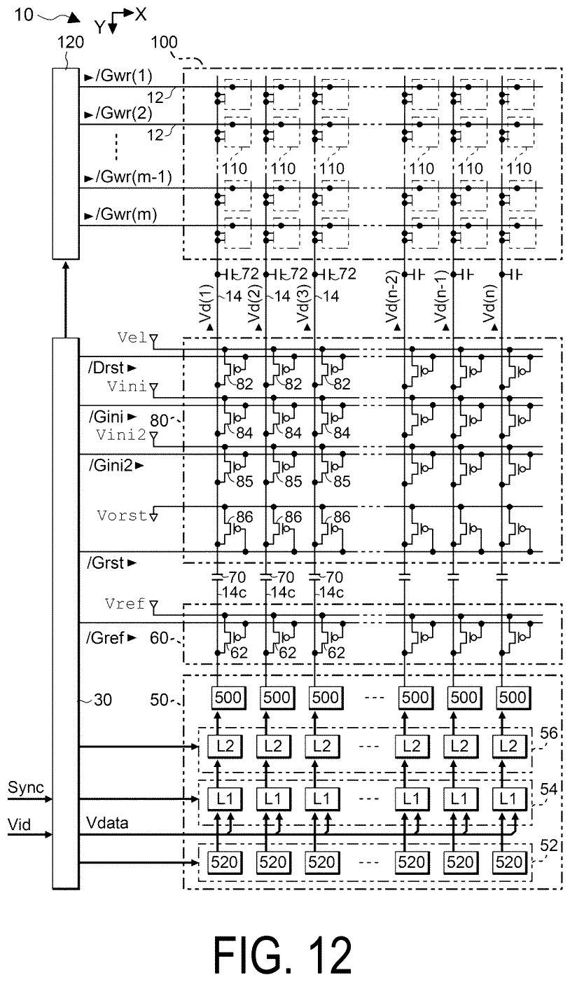

FIG. 12 is a block diagram illustrating an electrical configuration of an electro-optical device 10 according to a second embodiment. The electro-optical device 10 according to the second embodiment is different from the first embodiment illustrated in FIG. 2 in that transistors 85 are provided in one-to-one correspondence with data lines 14 in an initialization circuit 80.

A source node of the transistor 85 corresponding to the j-th column is connected to the power supply line of a potential Vini2, and a drain node of the transistor 85 is connected to the data line 14 of the j-th column. In addition, a control signal /Gini2 output from the control circuit 30 is commonly supplied to gate nodes of the transistors 85 in the respective columns. The potential Vini2 is higher than the potential Vini and less than the potential Vbk.

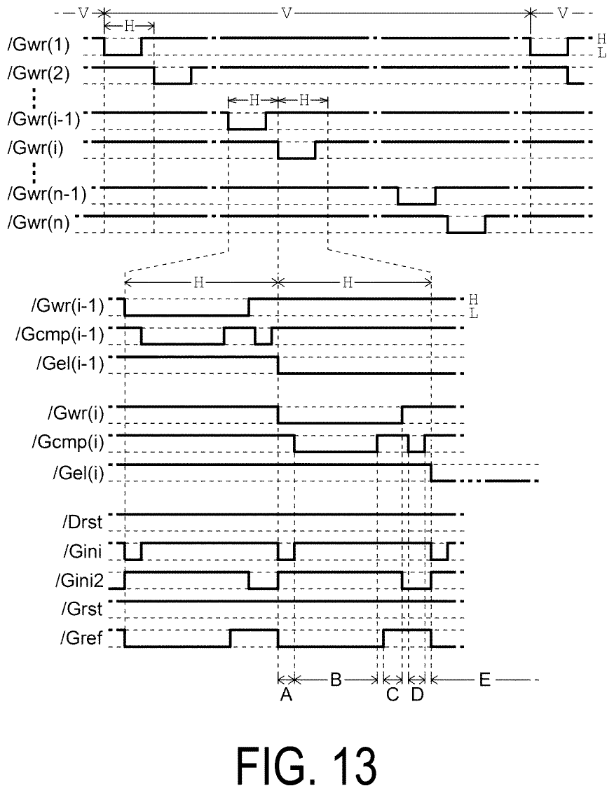

FIG. 13 is a timing chart for explaining the operation of the electro-optical device 10 according to the second embodiment.

The timing chart illustrated in FIG. 13 is different from that in FIG. 4 in that the control signal /Gini maintains the H level from the end of the write period (C) to the end of the drain set period (D), and in that the control signal /Gini2 is added. The control signal /Gini2 becomes the L level in the drain set period (D) of each horizontal scanning period (H) in one frame (V), and becomes the H level in other periods.

In the second embodiment, in the drain set period (D), the transistor 85 is turned to the ON state instead of the transistor 84 being turned to the OFF state in each column.

Therefore, in the drain set period (D), although not particularly illustrated, the potential Vini2 is supplied to the drain node d of the transistor 121 via the transistor 85, the data line 14 of the j-th column, and the transistor 123 in order in the pixel circuit 110 of the i-th row and the j-th column.

Therefore, in the second embodiment, since the potential Vini2 different from the potential Vini is used as the potential to be set to the drain node in the drain set period (D), the degree of freedom in setting the potentials Vini and Vini2 can be increased.

In the first embodiment or the second embodiment, the potential Vref plays a role of fixing the potential at one end of the capacitive element 70 when the potential of the data line 14, that is, the potential at the other end of the capacitive element 70 fluctuates in the initialization period (A) and the compensation period (B).

Therefore, a third embodiment in which the potential Vref is used as the potential to be set to the drain node in the drain set period (D) as a potential other than the potential Vini will be described.

### Third Embodiment

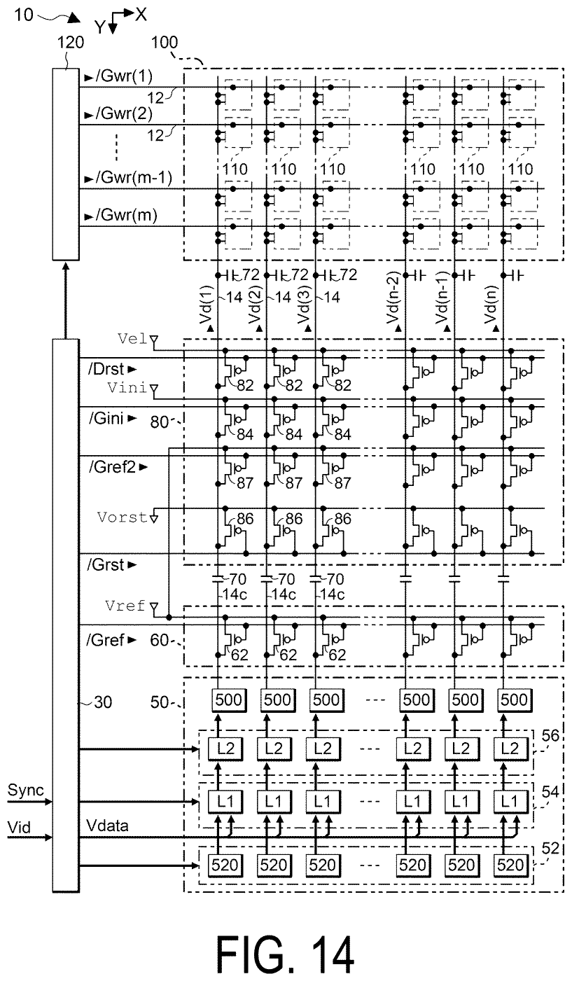

FIG. 14 is a block diagram illustrating an electrical configuration of an electro-optical device 10 according to a third embodiment. The electro-optical device 10 according to the third embodiment is different from the first embodiment illustrated in FIG. 2 in that transistors 87 are provided in one-to-one correspondence with data lines 14 in an initialization circuit 80.

A source node of the transistor 87 corresponding to the j-th column is connected to the power supply line of a potential Vref, and a drain node of the transistor 87 is connected to the data line 14 of the j-th column. In addition, a control signal /Gref2 output from the control circuit 30 is commonly supplied to a gate node of the transistor 87 in each column.

In the third embodiment, the control signal /Gref2 has the same waveform as the control signal /Gini2 in FIG. 13. In the third embodiment, the control signal /Gini has the same waveform as that in FIG. 13 instead of FIG. 4.

In the third embodiment, in the drain set period (D), the transistor 87 is turned to the ON state instead of the transistor 84 being turned to the OFF state in each column.

Therefore, in the drain set period (D), although not particularly illustrated, the potential Vref is supplied to the drain node d of the transistor 121 via the transistor 87, the data line 14 of the j-th column, and the transistor 123 in order in the pixel circuit 110 of the i-th row and the j-th column.

Therefore, in the third embodiment, since the potential Vref is used instead of the potential Vini as the potential to be set to the drain node in the drain set period (D), the degree of freedom in setting the potential Vini can be increased. In addition, in the third embodiment, since it is not necessary to generate a separate potential Vini2 as compared with the second embodiment, a circuit configuration for generating a potential can be simplified.

In the third embodiment, the potential Vref is set to be higher than or equal to the potential Vini and lower than the potential Vbk.

In the first to third embodiments, the initialization circuit 80 is configured to supply the potential to be set to the drain node in the drain set period (D), but another element other than the initialization circuit 80, specifically, another element in the pixel circuit 110 may be configured to supply the potential.

Therefore, a fourth embodiment in which the pixel circuit 110 itself supplies the potential to be set to the drain node in the drain set period (D) will be described.

Note that the fourth embodiment is different from the first embodiment in the configuration of the pixel circuit.

### Fourth Embodiment

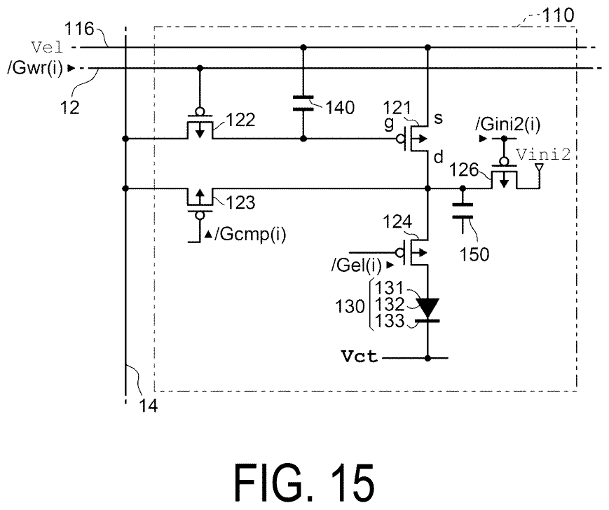

FIG. 15 is a diagram illustrating a pixel circuit 110 of an electro-optical device 10 according to a fourth embodiment. The pixel circuit 110 according to the fourth embodiment is different from that of the first embodiment illustrated in FIG. 3 in that a transistor 126 that electrically connects the drain node d of the transistor 121 and the power supply line of the potential Vini2 is provided in the drain set period (D).

The control signal /Gini2 (i) output from the control circuit 30 is commonly supplied to the gate node of the transistor 126 in the pixel circuit 110 of the i-th row. That is, the control signal /Gini2 (i) is supplied for each row.

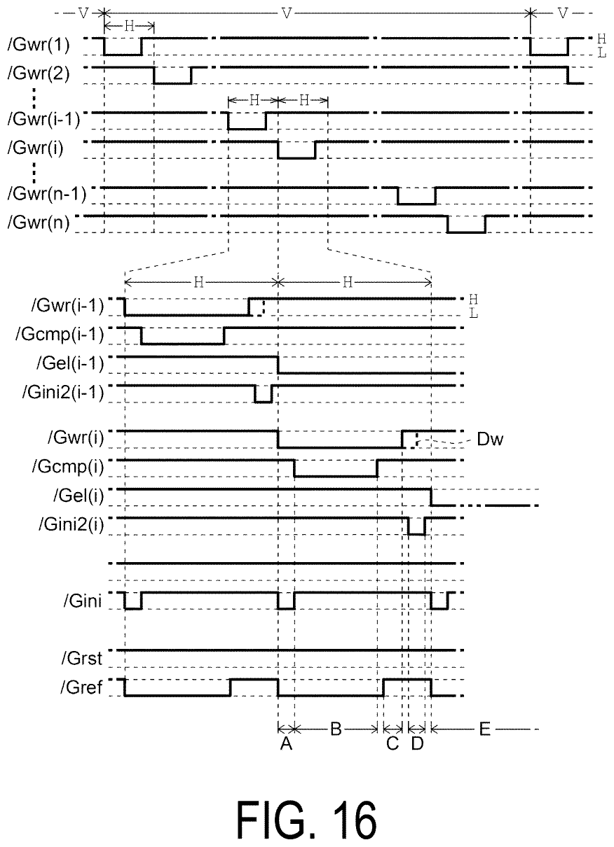

FIG. 16 is a timing chart illustrating the operation of the electro-optical device 10 according to the fourth embodiment, particularly waveforms of the control signal /Gini2 (i−1) of the (i−1)-th row and the control signal /Gini2 (i) of the i-th row.

As illustrated in the figure, in the drain set period (D) of the horizontal scanning period (H) in the i-th row, the control signal /Gini2 (i) becomes the L level, and the control signal /Gcmp (i) becomes the H level. Note that the fourth embodiment is similar to the second embodiment illustrated in FIG. 13 in that the control signal /Gini maintains the H level from the end of the write period (C) to the end of the drain set period (D).

In the fourth embodiment, in the drain set period (D) of the horizontal scanning period (H) in the i-th row, the transistor 123 is in the OFF state, and the transistor 126 is in the ON state. Therefore, in the drain set period (D), although not particularly illustrated, in the pixel circuit 110 of the i-th row and the j-th column, the potential Vini2 is supplied to the drain node d of the transistor 121 via the transistor 126.

Therefore, in the fourth embodiment, in the drain set period (D), the potential to be set to the drain node is supplied without passing through the data line 14 unlike the first to third embodiments, so that the power consumed by charging and discharging of the data line 14 (parasitic capacitance 72) is suppressed.

Furthermore, in the fourth embodiment, the drain set period (D) of the horizontal scanning period (H) in the i-th row can be executed independently of the other rows.

In addition, in the fourth embodiment, the drain set period (D) of the horizontal scanning period (H) in the i-th row can be executed in parallel with the write period (C). In the fourth embodiment, when the drain set period (D) and the write period (C) are executed in parallel, the compensation period (B) can be secured to be long by that amount, or the horizontal scanning period (H) can be shortened to achieve high resolution.

For example, as indicated by a broken line Dw in FIG. 16, the scanning signal /Gwr (i) may be changed from the L level to the H level in the drain set period (D) of the horizontal scanning period (H) in the i-th row. In this configuration, the write period (C) is executed in parallel halfway through the drain set period (D).

In such a configuration, when the transistor 122 changes from the ON state to the OFF state, the transistor 126 is in the ON state. Therefore, the influence when the transistor 122 is changed to the OFF state is suppressed. Note that this influence is specifically a phenomenon in which the potential of the drain node of the transistor 122 (the gate node g of the transistor 121) rises by the feed-through by the transistor 122, and further, the potential rise varies the potential of the drain node d via a capacitance parasitized between the gate node and the drain node of the transistor 121.

In the fourth embodiment, the potential to be set to the drain node d in the drain set period (D) is supplied via the transistor 126 separately provided in the pixel circuit 110, but the present disclosure is not limited to this configuration. In short, any configuration may be employed as long as the charge remaining in the parasitic capacitance 150 is reduced before the light-emission period (E).

Therefore, a fifth embodiment and a sixth embodiment will be described in which the charge remaining in the parasitic capacitance 150 is reduced before the light-emission period (E) by another element other than the transistor 126.

### Fifth Embodiment

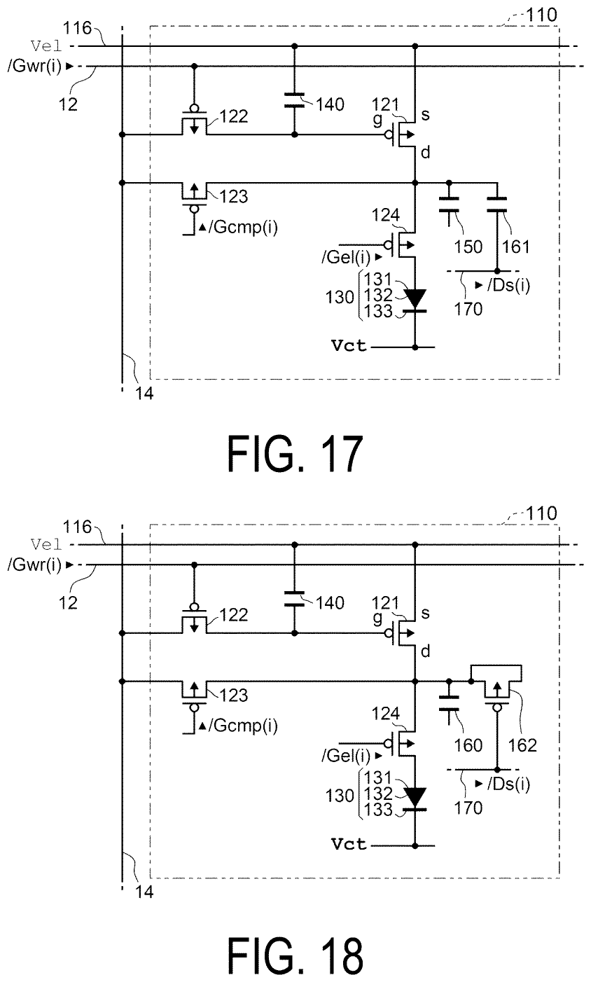

FIG. 17 is a diagram illustrating a pixel circuit 110 of an electro-optical device 10 according to a fifth embodiment. The pixel circuit 110 according to the fifth embodiment is different from the first embodiment illustrated in FIG. 3 in that a capacitive element 161 is provided between the drain node d of the transistor 121 and the discharge control line 170. Specifically, in the capacitive element 161, one electrode is connected to the drain node d of the transistor 121, and the other electrode is connected to the discharge control line 170. In the fifth embodiment, the capacitive element 161 is a metal capacitance having a metal insulator metal (MIM) structure in which an insulating layer is sandwiched between mutually different conductive layers in a semiconductor substrate. Note that the control signal/Ds (i) output from the control circuit 30 is commonly supplied to the discharge control line 170 of the pixel circuit 110 in the i-th row. That is, the control signal/Ds (i) is supplied for each row.

### Sixth Embodiment

FIG. 18 is a diagram illustrating a pixel circuit 110 of an electro-optical device 10 according to a sixth embodiment. The pixel circuit 110 according to the fifth embodiment is different from that of the fifth embodiment illustrated in FIG. 17 in that the capacitive element 161 is replaced with a capacitive element 162. Specifically, the capacitive element 162 is a MOS capacitance in which a source node and a drain node which are one electrode are connected to the drain node d of the transistor 121 and the other electrode is connected to the gate node. That is, the capacitive element 162 is formed by sandwiching the gate insulating layer of the transistor between the semiconductor layer (lower electrode) and the gate electrode layer (upper electrode) of the transistor.

Note that in the sixth embodiment, similarly to the fifth embodiment, the control signal/Ds (i) output from the control circuit 30 is commonly supplied to the discharge control line 170 of the pixel circuit 110 in the i-th row.

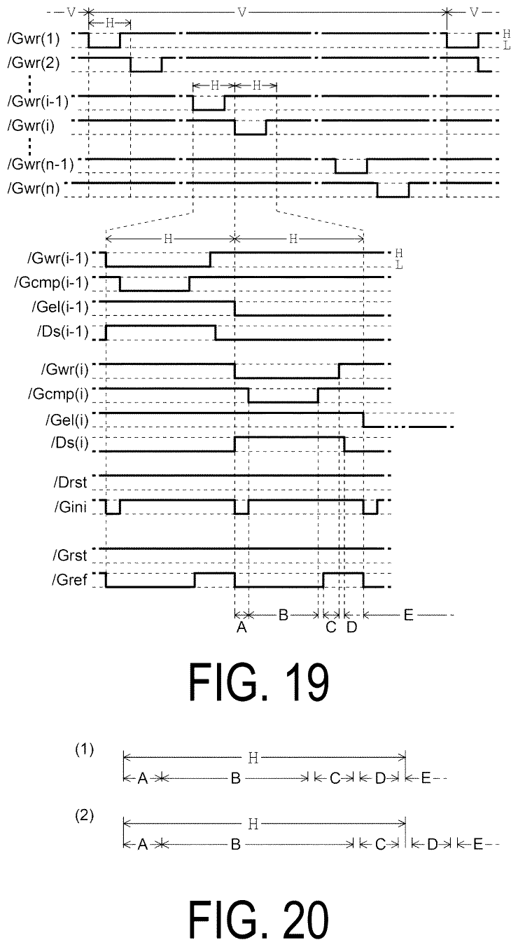

FIG. 19 is a timing chart illustrating the operation of the electro-optical device 10 according to the fifth or sixth embodiment, particularly waveforms of the control signal/Ds (i−1) of the (i−1)-th row and the control signal D/s (i) of the i-th row.

As illustrated in the drawing, the control signal D/s (i) of the i-th row becomes the H level at the beginning of the horizontal scanning period (H) in the i-th row, and the potential of the drain node d changes as the control signal D/s(i) decreases from the H level to the L level at the beginning of the drain set period (D), whereby the charge remaining in the parasitic capacitance 150 decreases.

### Modifications and Applications

In the first to six embodiments described above (hereinafter referred to as “embodiments and the like”), various modifications or applications are possible as described below.

In the embodiments and the like, as illustrated in (1) of FIG. 20, the initialization period (A) to the drain set period (D) fall within the one horizontal scanning period (H), but the drain set period (D) does not need to fall into the one horizontal scanning period (H). Specifically, the initialization period (A), the compensation period (B), and the write period (C) need to fall within one horizontal scanning period (H), but the drain set period (D) may be after the one horizontal scanning period and before the light-emission period (E), as illustrated in (2) of FIG. 20.

In this manner, when the drain set period (D) comes after one horizontal scanning period, the period that needs to fall within the horizontal scanning period (H), in particular, the compensation period (B) can be secured to be long, or the horizontal scanning period (H) can be shortened for higher resolution.

In the embodiments and the like, the reason the drain set period (D) is executed after the write period (C) will be described. When the write period (C) ends in the horizontal scanning period (H) of the i-th row, the transistor 122 changes from the ON state to the OFF state, specifically, the potential of the scanning signal /Gwr (i) rises from the L level to the H level. The potential rise propagates through a capacitance parasitized between the gate node and the drain node of the transistor 122, and rises the potential of the drain node of the transistor 122, that is, the gate node g of the transistor 121. The potential rise at the gate node g of the transistor 121 propagates through a capacitance parasitized between the gate node and the drain node of the transistor 121, and rises the potential of the drain node d of the transistor 121.

Therefore, it is because it is efficient to execute the drain set period (D) after the potential of the drain node d is raised at the end of the write period (C).

In the embodiments and the like, the transistors 82 and 86 are provided for description in comparison with the comparative example, but as described above, the transistors are unnecessary in the embodiments and the like, and thus may be omitted.

In the embodiments and the like, the OLED 130 is described as an example of the light-emitting element, but other light-emitting elements may be used. For example, an LED may be used as the light-emitting element, or a liquid crystal element combined with an illumination mechanism may be used. That is, the light-emitting element may be an electro-optical element which enters an optical state according to the voltage of the data line 14.

In the embodiments and the like, a 10-bit conversion example is described as the DA conversion circuit 500, but the present disclosure is not limited thereto.

The channel type of the transistors 64, (82), 84, 85, (86), 87, 121 to 126, and the like are not limited to the embodiments and the like. In addition, the channel of these transistors and the like may be appropriately changed, or may be appropriately replaced with a transmission gate.

### Electronic Apparatus

Next, an electronic apparatus to which the electro-optical device 10 according to the embodiments and the like are applied will be described. The electro-optical device 10 is suitable for application of a small pixel size and high definition display. Consequently, a head-mounted display will be described as an example of the electronic apparatus.

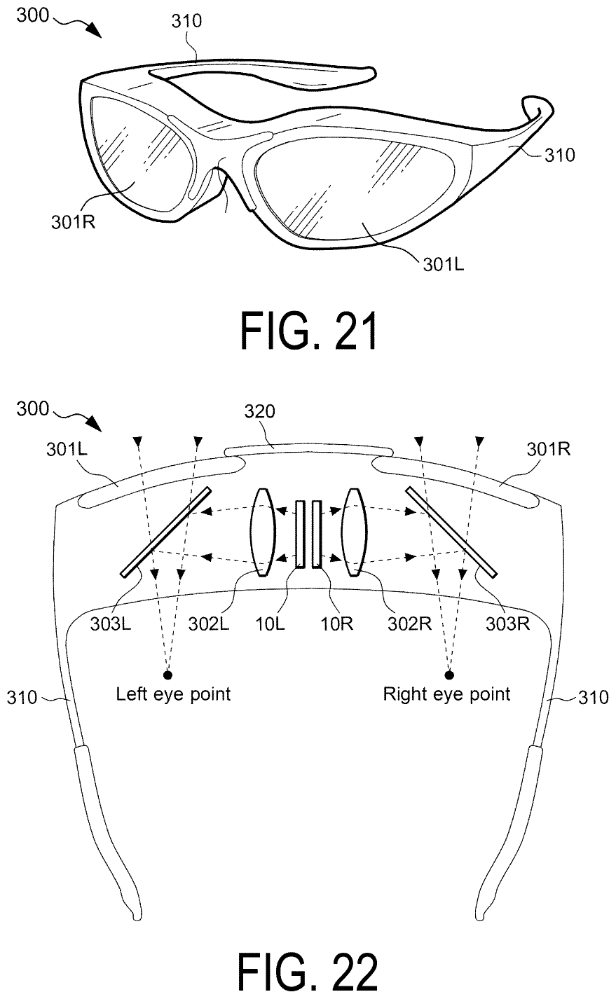

FIG. 21 is a diagram illustrating appearance of a head-mounted display, and FIG. 22 is a diagram illustrating an optical configuration thereof.

First, as illustrated in FIG. 21, a head-mounted display 300 includes, in terms of appearance, temples 310, a bridge 320, and lenses 301L and 301R, similar to typical eye glasses. In addition, as illustrated in FIG. 22, in the head-mounted display 300, an electro-optical device 10L for a left eye and an electro-optical device 10R for a right eye are provided in the vicinity of the bridge 320 and on the far side (the lower side in the drawing) of the lenses 301L and 301R.

An image display surface of the electro-optical device 10L is disposed to be on the left side in FIG. 22. Thus, a display image by the electro-optical device 10L is emitted via an optical lens 302L in a 9-o'clock direction in the drawing. A half mirror 303L reflects the display image by the electro-optical device 10L in a 6-o'clock direction, and transmits light entering from a 12-o'clock direction. An image display surface of the electro-optical device 10R is disposed on the right side opposite to the electro-optical device 10L. Thus, the display image by the electro-optical device 10R is emitted via the optical lens 302R in a 3-o'clock direction in the drawing. A half mirror 303R reflects the display image by the electro-optical device 10R in a 6-o'clock direction, and transmits light entering from a 12-o'clock direction.

In this configuration, a wearer of the head-mounted display 300 can observe the display image by the electro-optical devices 10L and 10R in a see-through state in which the display image is overlapped with the outside.

Furthermore, in the head-mounted display 300, an image for the left eye is displayed by the electro-optical device 10L, and an image for the right eye is displayed by the electro-optical device 10R in the images for both eyes involving parallax, so that it enables the wearer to sense the displayed image as having depth or stereoscopic effect.

Note that the electronic apparatus including the electro-optical device 10 can be applied not only to the head mounted display 300 but also to an electronic viewfinder in a video camera, a lens-interchangeable digital camera, or the like, a display unit of a smartwatch, a wearable device, a light valve of a projection-type projector, or the like.

### Supplementary Note

For example, the following aspects are understood from the modes illustrated above.

An electro-optical device according to one aspect (first aspect) includes a pixel circuit provided in correspondence with a scanning line and a data line, in which the pixel circuit includes a first transistor and a light-emitting element, the first transistor supplies current corresponding to a voltage between a gate node of the first transistor and a source node of the first transistor to the light-emitting element in a light-emission period, sets the data line to a first potential in an initialization period before the light-emission period, sets the gate node of the first transistor to a second potential corresponding to a threshold voltage of the first transistor in a compensation period after the initialization period and before the light-emission period, sets the gate node of the first transistor to a third potential corresponding to a luminance of the light-emitting element from the second potential in a first period after the compensation period and before the light-emission period, and sets the drain node of the first transistor to a fourth potential greater than or equal to the first potential and smaller than the third potential in a second period after the first period and before the light-emission period.

According to the electro-optical device of the first aspect, the charge remaining in the parasitic capacitance at the drain node of the first transistor is prevented from flowing into the light-emitting element when reaching the light-emission period. Therefore, slight light emission due to inflow of charges is suppressed, and a high contrast ratio is easily realized.

Note that the transistor 121 is an example of the first transistor. In the first embodiment, the potential Vini is an example of the first potential and the fourth potential. The threshold equivalent potential (Vel-Vth) at the end of the compensation period (B) is an example of the second potential. The write period (C) is an example of a first period. The potential Vbk supplied to the gate node g of the transistor 121 in the write period (C) is an example of the third potential. The drain set period (D) is an example of a second period. In the initialization period, the gate node of the first transistor is preferably at the first potential.

In the electro-optical device according to a specific second aspect of the first aspect, the fourth potential is the same as the first potential. According to the electro-optical device of the second aspect, since the fourth potential is also used as the first potential, the circuit that generates the potential is simplified.

In the electro-optical device according to a third specific aspect of the first aspect, the fourth potential is higher than the first potential. In a case where the gate node of the first transistor is the first potential in the initialization period and the second potential corresponding to the threshold voltage in the compensation period, the first potential has various restrictions. According to the electro-optical device of the third aspect, since a potential different from the first potential is used as the fourth potential, a degree of freedom in setting the fourth potential is increased.

The potential Vini2 in the second embodiment or the potential Vref in the third embodiment is an example of the fourth potential.

In the electro-optical device according to a specific fourth aspect of the first aspect, the drain node of the first transistor is set to the fourth potential via the data line in the second period.

An electro-optical device according to a specific fifth aspect of the first aspect includes a second transistor that electrically connects a power supply line of the fourth potential and a drain node of the first transistor in the second period.

An electro-optical device according to a specific sixth aspect of the first aspect includes a capacitive element in which one electrode is connected to a drain node of the first transistor and the other electrode is connected to a discharge control line.

In the electro-optical device according to a specific seventh aspect of the sixth aspect, the capacitive element is a metal capacitance. Note that the capacitive element 161 is an example of the metal capacitance.

In the electro-optical device according to a specific eighth aspect of the sixth aspect, the capacitive element is a MOS capacitance. Note that the capacitive element 162 is an example of the MOS capacitance.

An electronic apparatus according to a ninth aspect includes the electro-optical device according to any one of first to eighth aspects.

What is claimed is:

1. An electro-optical device comprising:
a pixel circuit provided in correspondence with a scanning line and a data line; wherein
the pixel circuit includes a first transistor and a light-emitting element,
the first transistor,
supplies current corresponding to a voltage between a gate node of the first transistor and a source node of the first transistor to the light-emitting element in a light-emission period,
sets the data line to a first potential in an initialization period before the light-emission period,
sets the gate node of the first transistor to a second potential corresponding to a threshold voltage of the first transistor in a compensation period after the initialization period and before the light-emission period,
sets the gate node of the first transistor to a third potential corresponding to a luminance of the light-emitting element from the second potential in a first period after the compensation period and before the light-emission period, and
sets the drain node of the first transistor to a fourth potential greater than or equal to the first potential and smaller than the third potential in a second period after the first period and before the light-emission period.

2. The electro-optical device according to claim 1, wherein the fourth potential is the same as the first potential.

3. The electro-optical device according to claim 1, wherein the fourth potential is higher than the first potential.

4. The electro-optical device according to claim 1, wherein the drain node of the first transistor is set to the fourth potential via the data line in the second period.

5. The electro-optical device according to claim 1, further comprising a second transistor that electrically connects a power supply line of the fourth potential and a drain node of the first transistor in the second period.

6. The electro-optical device according to claim 1, wherein further comprising a capacitive element having one electrode connected to a drain node of the first transistor and the other electrode connected to a discharge control line.

7. The electro-optical device according to claim 6, wherein the capacitive element is a metal capacitance.

8. The electro-optical device according to claim 6, wherein the capacitive element is a MOS capacitance.

9. An electronic apparatus comprising the electro-optical device according to claim 1.
